(19) United States
(12) Patent Application Publication
(10) Pub. No.: US 2026/0023197 A1
(43) Pub. Date: Jan. 22, 2026

(54) LIQUID-FILLABLE DUAL LENS ELEMENT

(71) Applicant: The Coca-Cola Company, Atlanta, GA (US)

(72) Inventors: Jared KOZEL, Atlanta, GA (US); Kimberly BLASNIK, Atlanta, GA (US); Randall BOURQUIN, Atlanta, GA (US)

(73) Assignee: The Coca-Cola Company, Atlanta, GA (US)

(21) Appl. No.: 19/271,001

(22) Filed: Jul. 16, 2025

Related U.S. Application Data
(60) Provisional application No. 63/672,534, filed on Jul. 17, 2024.

(51) Int. Cl. G02B 3/14; G02B 7/02

(52) U.S. Cl. CPC G02B 3/14; G02B 7/02

(57) ABSTRACT

A system is provided including a liquid-fillable dual lens element having a reservoir member including a first opening, a reservoir and a distal lens that can be fillable with a liquid and allow light to pass through the first opening, the reservoir, the liquid, and the distal lens. The reservoir member can also include a lens member allowing liquid to be added to the reservoir, cap the first opening, and allow light to enter the reservoir. A base element can hold the liquid-fillable dual lens element over a camera lens such that the camera lens can access light through the liquid-fillable dual lens element.

### CROSS-REFERENCE TO RELATED APPLICATION

This application claims the benefit of U.S. provisional patent application No. 63/672,534, filed 17 Jul. 2024, titled: Liquid-Fillable Dual Lens Element.

### BACKGROUND

Portable devices capable of capturing photos and videos are widely available and include cameras, smart phones, tablets, etc. These devices come at various price points and configurations, and many are everyday carry items for consumers around the world.

The quality of pictures produced by such portable devices improves with each successive generation. Currently, many users (including those with little or no formal training in photography) are able with a little practice to produce high quality photographs and videos, rivaling those produced by professional photographers.

These efforts have been greatly helped by a large number of easy to use electronic filters, adding to the enjoyment of capturing images and videos, and encouraging users to devote more time to the visual art of photography.

### SUMMARY

In an example embodiment, a liquid-fillable dual lens element has a reservoir member including a reservoir, a first opening and an opposing distal aperture. The distal aperture includes a distal lens. The liquid-fillable dual lens element also has a lens member with a receiving lens. The lens member is configured to couple with the first opening of the reservoir member so that liquid can be securely held within the reservoir between the distal lens and the receiving lens.

In another example embodiment, a system includes a liquid-fillable dual lens element and a base element. The liquid-fillable dual lens element includes a reservoir member having a first opening, a reservoir and a distal lens. The reservoir member is configured to be fillable with a liquid and allow light to pass through the first opening, the reservoir, the liquid and the distal lens. The liquid-fillable dual lens element also includes a lens member with a receiving lens configured to allow the liquid to be added to the reservoir, cap the first opening, and allow light to enter the reservoir. The base element can hold the dual lens element over a camera lens such that the camera lens can access light through the liquid-fillable dual lens element.

In yet another example embodiment, a system includes a liquid-fillable dual lens element including a reservoir and a removable lens member configured to allow liquid to be added to and removed from the reservoir. The system further includes a base element configured to hold the liquid-fillable dual lens element over a smartphone camera lens such that the liquid-fillable dual lens element can act as a filter allowing light to pass through an entire longitudinal length of the liquid-fillable dual lens element, and any liquid enclosed therein, to the camera lens.

This summary is not intended to identify key or essential features of the claimed subject matter, nor is it intended to be used as an aid in limiting the scope of the claimed subject matter. Other principal features of the current disclosure will become apparent to those skilled in the art upon review of the following drawings, the detailed description, and the appended claims.

### BRIEF DESCRIPTION OF THE DRAWINGS

Illustrative embodiments will be described referring to the accompanying drawings, wherein like numerals denote like elements.

FIG. 1 depicts a system including a liquid fillable dual lens element and a base element in accordance with an illustrative implementation.

FIG. 2 depicts a liquid-fillable dual lens element in accordance with another illustrative implementation.

FIG. 3 depicts a cross-sectional view of a liquid-fillable dual lens element in accordance with another illustrative implementation.

FIG. 4 depicts a liquid-fillable dual lens element and a base element in accordance with another illustrative implementation.

FIG. 5 depicts components of a base element in accordance with yet another illustrative implementation.

### DETAILED DESCRIPTION

In the following description, numerous details are set forth to provide an understanding of some embodiments of the present disclosure. However, it will be understood by those of ordinary skill in the art that the system, its components, and its associated methodology may be practiced without these details and that numerous variations or modifications from the described embodiments may be possible.

As described herein, various techniques and technologies can be associated with the use of a liquid-fillable dual lens element in photography. Deployment of such a liquid-fillable dual lens element can enhance the aesthetics of photos and videos and increase the enjoyment of users as they interact with their cameras.

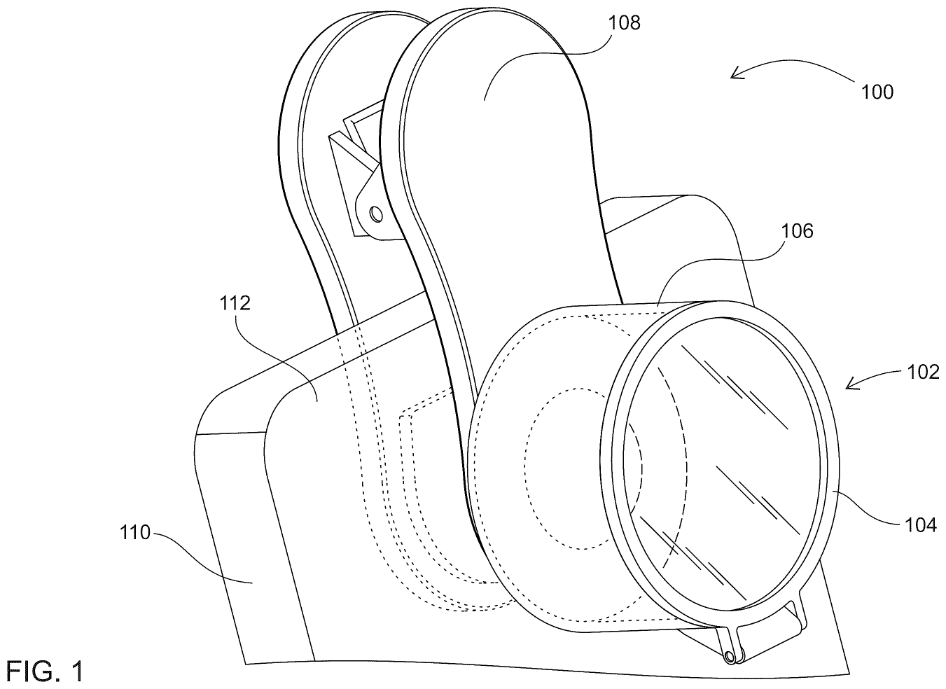

FIG. 1 illustrates a system 100, in accordance with one possible implementation, including a liquid-fillable dual lens element 102, comprising a lens member 104 and a reservoir member 106, positioned via a base element 108 over a device 110. It will be understood that device 110 can include any device capable of capturing pictures or video, including, for example, a smartphone, a tablet, a laptop, a digital camera, an analog camera, etc.

Base 108 can be employed to hold liquid-fillable dual lens element 102 over any camera lens or lenses present on device 110, including over a lens of a center-oriented camera on a front face 112 of device 110, over a lens of a camera on a rear face of device 110 opposite front face 112, and over multiple lenses on either the rear face or the front face 112 face. For instance, if multiple lenses are co-located together on device 110, base 108 can be employed to mount liquid-fillable dual lens element 102 over all of the multiple lenses as desired.

Base clement 108, can comprise anything capable of holding liquid-fillable dual lens element 102 over one or more lenses of one or more cameras on device 110. This includes not only a spring loaded clip made from a stiff material (as illustrated in FIG. 1), but also other types of clips, including clips made at least in part of elastic materials with or without separate springs. It also includes various clamps, bands, cords, adhesives (including removable adhesives), etc., made from any materials known in the art.

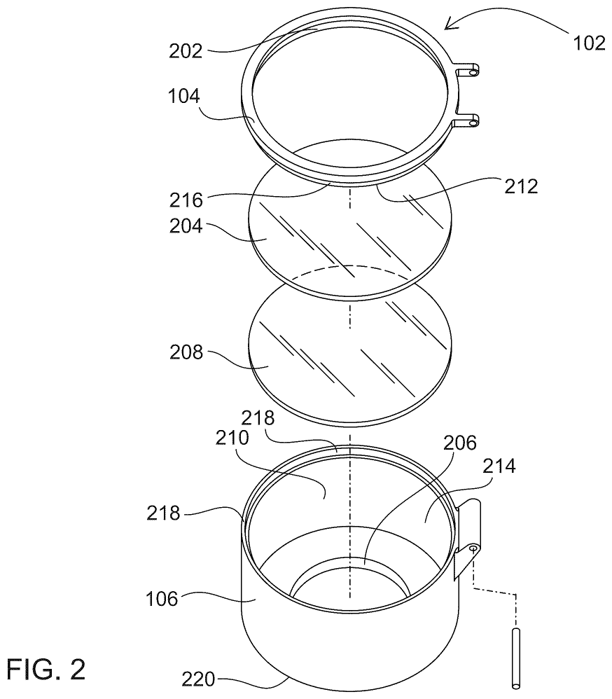

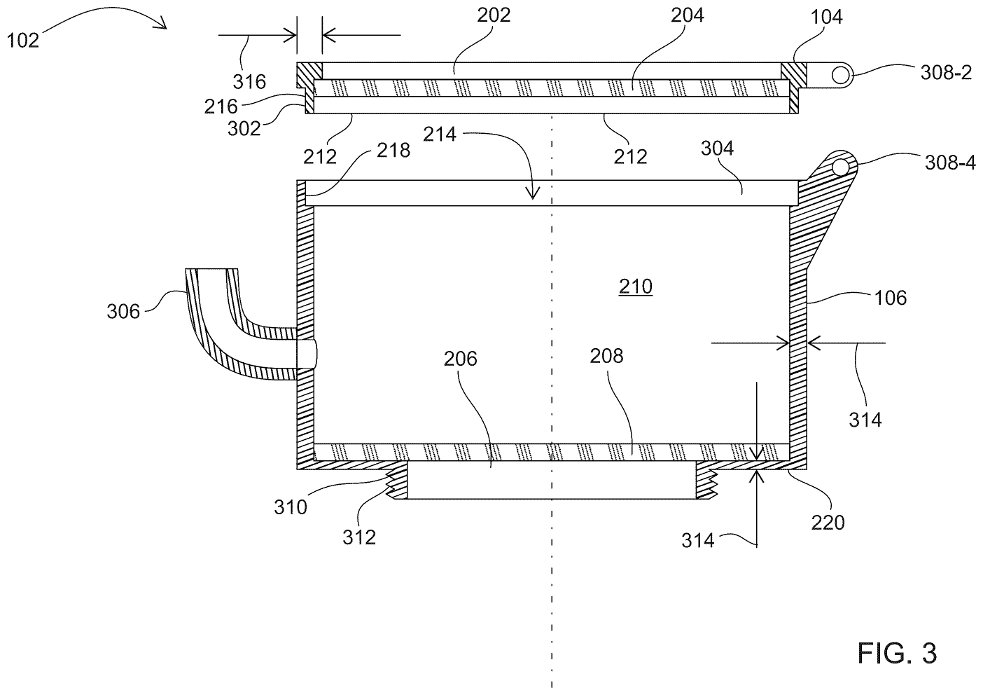

FIGS. 2 and 3 illustrate possible configurations of liquid-fillable dual lens element 102 in accordance with various possible implementations. As shown in FIG. 2., lens member 104 includes a receiving aperture 202 with a receiving lens 204 residing therein and/or thereacross, and reservoir member 106 includes a distal aperture 206 with a distal lens 208 residing therein and/or thereacross.

Lens member 104 and reservoir member 106 can utilize any mating configuration known in the art to obtain coupling with one another such that any liquid within a reservoir 210 of reservoir member 106 can be at least substantially contained within liquid-fillable dual lens element 102.

For example, in one possible implementation, a mating edge 212 of lens member 104 can be placed into a first opening 214 of reservoir member 106 opposite distal aperture 206. In one possible scenario, lens member 104 can be completely detached from reservoir member 106 allowing a user to fill reservoir member 106, either partially or fully, with any liquid desired, before reattaching lens member 104 to reservoir member 106. In one possible embodiment, lens member 104, and reservoir member 106 can include flange portions 216 and 218, respectively.

FIG. 3 illustrates a cross-sectional view of liquid-fillable dual lens element 102 in accordance with various possible implementations. Mating topography 302, 304, can be included on flange portions 216, 218 (respectively) such that lens member 104 may be permanently or detachably attached to reservoir member 106. In one possible implementation, mating topography 302, 304 can include complementary threads on flange portions 216 and 218 enabling lens element 104 to be screwed on to, and off of, reservoir element 106.

In other possible implementations, mating topography 302, 304 can include a boss and groove design and/or one or more ridges enabling lens member 104 and reservoir member 106 to detachably or permanently snap onto one another. In still other possible implementations, removeable and/or permanent gaskets, and/or adhesives can be utilized in conjunction with flange portions 216 and 218 to detachably or permanently couple lens member 104 to reservoir member 106.

In other possible embodiments, lens member 104 can be permanently fixed to reservoir member 106 (including scenarios where lens member 104 and reservoir member 106 are a single element) and liquid can be added to and removed from reservoir member 106 through any intake port 306 known in the art, such as a flexible nipple, a cap, etc. Such an intake port 306 can be located wherever desired on lens member 104 and/or on reservoir member 106.

In still another possible embodiment, lens member 104 can be fixedly attached to reservoir member 106 via a hinge 308 (see hinge components 308-2 and 308-4 in FIG. 3) coupling lens member 104 to reservoir member 106, such that liquid can be added to, or removed from, reservoir member 106 by opening and closing lens member 104 by rotating lens member 104 about hinge 308 relative to reservoir member 106.

In some possible implementations, reservoir member 106 may include an attachment member 310, configured to allow coupling of liquid-fillable dual lens element 102 with base 108. Attachment member 310 can include any structure known in the art capable of coupling reservoir member 106 to base element 108 without blocking a flow of light through dual lens element 102. In one possible implementation, attachment member 310 can comprise a cylindrical flange extending from a distal side 220 of reservoir member 106. This flange can include any coupling topology 312 known in the art, such as threads, a boss and groove design, a ridge pattern, etc., allowing reservoir member 104 to couple with base 108. Alternately, the flange can be smooth, relying on friction between it and base member 108 to maintain coupling between base member 108 and reservoir member 106. Adhesives, gaskets, etc., in any possible configuration and/or combination, can be employed with attachment member 310 in its various possible configurations to establish and/or improve coupling between reservoir member and base 108.

It will be understood that liquid-fillable dual lens element 102 and its components may have any dimensions desired. For example, in one possible embodiment, distal aperture 206 may have a diameter of approximately 17 mm, reservoir element 106 may have a diameter of approximately 30 mm, receiving aperture 202 may have a diameter of approximately 27 mm, and lens member 104 may have a diameter of approximately 30 mm. In one possible implementation, liquid-fillable dual lens element 102 can hold 0.5 ounces or more of liquid in reservoir 210.

Wall thicknesses of the elements of liquid-fillable dual lens element 102 may also vary as desired. For example, in one possible embodiment, a wall thickness 314 of reservoir member 106 may be approximately 1 mm and a wall thickness 316 of lens member 104 may be approximately 1 mm, though other larger or smaller thicknesses can also be used.

Moreover, a longitudinal distance that light will travel through liquid-fillable dual lens element 102 when lens element 104 is coupled to reservoir member 106 can also vary based on sizes chosen for lens member 104 and reservoir member 106. For example, in one possible embodiment, light can travel approximately 18.5 mm through receiving lens 204, reservoir 210 and distal lens 208.

It will further be noted that lens member 104 and reservoir member 106 can be made of any materials known in the art, including metals (such as aluminum, steel, etc.), plastics, carbon fiber composites, plant-based materials (such as wood, etc.) and any combinations thereof. Moreover, receiving lens 204 and distal lens 208 can be made of any materials known in the art including, glass, plastic, etc., in any possible combinations. Further, receiving lens 204 and distal lens 208 can magnify, reduce or have no effect on light and images passing therethrough. This includes any possible combinations of such functionality. For example, receiving lens 204 may magnify while distal lens 208 may reduce or have no effect on light passing therethrough. In another possible example, distal lens 208 may magnify while receiving lens 204 may reduce or have no effect on light passing therethrough. In this way, receiving lens 204 and distal lens 208 can be selected to interact in any desirable manner with any liquid and gas present in reservoir member 106 such that magnification, reduction or neither can occur when light passes through liquid-fillable dual lens element 102.

Any liquid known in the art can be placed within reservoir member 106, including liquids of various colors. In one possible implementation, a colored tea beverage can be used in reservoir member 106, allowing liquid-fillable dual lens element 102 to act like a filter, such that one or more pleasing colors and/or hues can be imparted to light passing therethrough. In one possible aspect, the liquid placed into reservoir member can impart a filter effect simulating lighting conditions of just before sunset, or what some photographers call “The Golden Hour”. In this manner, photographers can employ liquid-fillable dual lens element 102 to capture images with Golden Hour visual effects at any time of day.

Liquid-fillable dual lens element 102 and its elements can also have any cross-sectional shape known in the art, including, for example circular, oval, rectangular, etc. This cross section can be uniform along a longitudinal length from receiving aperture 202 to distal aperture 206 or it can vary in any manner desired. For example, in one possible implementation, a cross-sectional diameter of reservoir member 106 can decrease along a longitudinal length from where reservoir member 106 is coupled to lens member 104, to distal aperture 206. In another possible implementation, a cross-sectional diameter of reservoir member 106 can increase along a longitudinal length from where reservoir member 106 is coupled to lens member 104, to distal aperture 206.

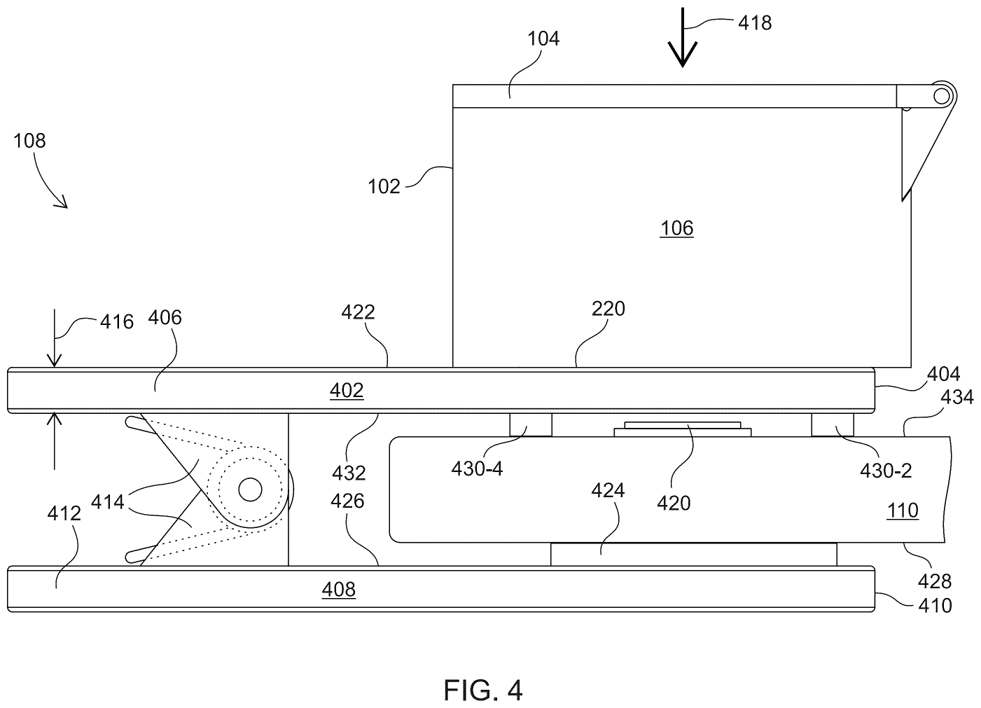

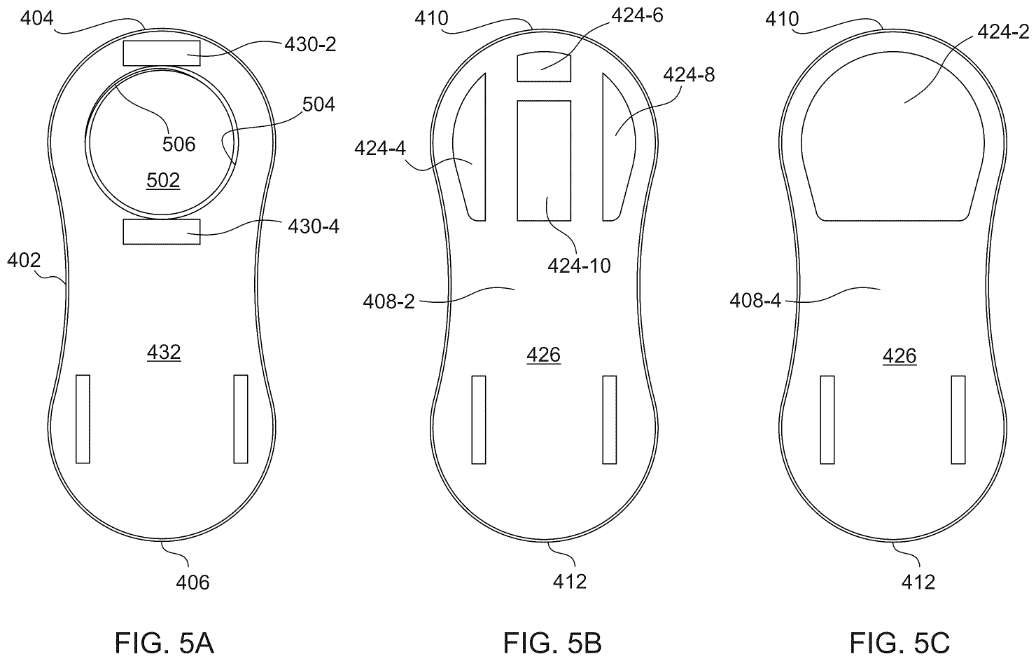

FIGS. 4 and 5 illustrate base element 108 in accordance with various possible implementations. For example, in FIG. 4 base clement 108 comprises a carrier member 402 including a carrier end 404 and an opposing end 406, a friction member 408 including a carrier end 410 and an opposing end 412, and a hinge assembly 414.

In one possible aspect, hinge assembly 414 can include any spring functionality and/or geometry known in the art configured to bias end 404 of carrier member 402 and end 410 of friction member 408 toward one another. The spring functionality of hinge assembly 414 can include a spring, an elastic member, etc. In one possible implementation, a user can rotate ends 404 and 410 away from one another by pinching opposing ends 406 and 412 towards one another.

Viewing FIG. 5 in conjunction with FIG. 4, carrier member 402 can include an aperture 502 though its thickness 416. Aperture 502 can have a diameter as large or larger than distal aperture 206 of reservoir member 106, such that light 418 passing through liquid-fillable dual lens element 102 can travel through the various elements of liquid-fillable dual lens element 102 (including any liquid or gas enclosed therein) and arrive at one or more camera lenses 420 on device 110 being held between carrier member 402 and friction member 408 of base 108 without being obstructed by any portion of carrier member 402.

In implementations where reservoir member 106 includes attachment member 310, aperture 502 can be large enough to accommodate attachment member 310. When attachment member 310 is employed without any gaskets or adhesive, aperture 502 can be large enough such that attachment member 310 can fit snugly into aperture 502 without appreciable slippage. Alternately, when attachment member 310 is employed with adhesive, and/or one or more gaskets or liners, etc., aperture 502 can be large enough such that attachment member 310 and any adhesive, and/or one or more gaskets or liners present will fit snugly into aperture 502 without appreciable slippage,

In scenarios in which attachment member 310 includes coupling topology 312, it will be understood that a mating surface 504 defining all or part of aperture 502 can include complementary coupling topology 506 (including threads, boss and guide topology, one or more circumferential ribs, or any possible combination thereof) to securely couple attachment member 310 to carrier member 402. In some possible embodiments, thickness 416 of carrier member 402 is sufficient to accept an entirety of attachment member 310.

In other possible embodiments in which attachment member 310 is not present on reservoir member 106, liquid-fillable dual lens element 102 can be secured to carrier member 402 by gluing or otherwise adhering distal side 220 of reservoir member 106 to an attachment side 422 of carrier member 402.

In one possible implementation, one or more pads 424 can be located on a contact surface 426 of friction member 408 at or near carrier end 410 to improve a grip of base element 108 on device 110 and/or prevent damage, such as scratching, of a face 428 of device 110 proximate friction member 408. Pads 424 can cover as large or small an area of carrier end 410 as desired and be of a single piece construction (such as pad 424-2), or it can be employed as several separate pieces (such as pads 424-4-424-10) at various locations on carrier end 410.

In a similar manner, one or more pads 430, if and as desired, can be placed at or near carrier end of 404 of carrier member 402. Pads 430 can be employed in any configuration desired and in any size or sizes desired. In one possible embodiment, pad(s) 430 can be placed on contact surface 432 of carrier member 402 at or near carrier end 404 to improve a grip of base element 108 on device 110, to maintain a desired distance of contact surface 432 from the one or more lenses 420 on device 110, and/or prevent damage, such as scratching, of a face 434 of device 110 proximate carrier member 402 and/or of lens (cs) 420. Pads 424 and pads 430 can be made of any material known in the art including rubber, foam, plastic, etc., and can come in any size, color and/or thickness known in the art.

Carrier member 402 and friction member 408 can be made of any materials desired, including wood, metal, plastic, rubber, or any combination thereof.

It will be understood that even though carrier member 402 and friction member 408 are illustrated as having slender bodies with bulbous ends, carrier member 402 and friction member 408 can comprise any shapes known in the art, including for example, rectangles and ovals of various dimensions, rectangles with triangular ends, rectangles with ends shapes like various objects (flowers, hearts, animals, etc.), and so on.

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” means “one or more”. Still further, using “and” or “or” is intended to include “and/or” unless specifically indicated otherwise. The illustrative embodiments may be implemented as a method, apparatus, or article of manufacture using standard engineering techniques.

The foregoing description of illustrative embodiments of the disclosed subject matter has been presented for purposes of illustration and of description. It is not intended to be exhaustive or to limit the disclosed subject matter to the precise form disclosed, and modifications and variations are possible in light of the above teachings or may be acquired from practice of the disclosed subject matter. The embodiments were chosen and described in order to explain the principles of the disclosed subject matter and as practical applications of the disclosed subject matter to enable one skilled in the art to utilize the disclosed subject matter in various embodiments and with various modifications as suited to the particular use contemplated. It is intended that the scope of the disclosed subject matter be defined by the claims appended hereto and their equivalents.

What is claimed is:

1. A liquid-fillable dual lens element comprising:
a reservoir member including a reservoir, a first opening, and an opposing distal aperture, the distal aperture including a distal lens; and
a lens member comprising a receiving lens, the lens member being configured to couple with the first opening of the reservoir member such that liquid can be securely held within the reservoir between the distal lens and the receiving lens.

2. The liquid-fillable dual lens element of claim 1, wherein a diameter of the first opening of the reservoir member is greater than a diameter of the distal aperture of the reservoir member.

3. The liquid-fillable dual lens element of claim 1, wherein the lens member and the first opening of the reservoir member include complementary mating topography such that the lens member and the reservoir member can be detachably coupled.

4. The liquid-fillable dual lens element of claim 1, wherein the reservoir member has a substantially circular cross section.

5. The liquid-fillable dual lens element of claim 1, wherein the reservoir is configured to hold at least 0.5 ounces of liquid.

6. The liquid-fillable dual lens element of claim 1, wherein the reservoir member further includes an attachment member configured to fit into an aperture in a base element, such that the liquid-filled dual lens element can be removeable fitted over a camera lens via the base member, allowing the liquid-filled dual lens element to act as a filter for the camera lens.

7. The liquid-fillable dual lens element of claim 1, wherein the reservoir member is made of aluminum.

8. A system comprising:
a liquid-fillable dual lens element including:
a reservoir member comprising a first opening, a reservoir, and a distal lens, the reservoir member being configured to be fillable with a liquid and allow light to pass through the first opening, the reservoir, the liquid and the distal lens; and
a lens member including a receiving lens, the lens member being configured to allow the liquid to be added to the reservoir, cap the first opening, and allow light to enter the reservoir; and
a base element configured to hold the liquid-fillable dual lens element over a camera lens such that the camera lens can access light through the liquid-fillable dual lens element.

9. The system of claim 8, wherein the lens member can be detachably attached to the reservoir member.

10. The system of claim 9, wherein the lens member includes threads complementary to threads on the reservoir member.

11. The system of claim 8, wherein the base element includes one or more pads to cushion one or more interfaces between the base element and a device on which the camera lens is found.

12. The system of claim 8, wherein the base element comprises a spring-loaded clip.

13. The system of claim 8, wherein the base element is made at least in part of plastic.

14. The system of claim 8, wherein at least a portion of the liquid-fillable dual lens element protrudes into an aperture formed through a thickness of a member of the base element.

15. The system of claim 14, wherein the at least a portion of the dual lens element includes coupling topography complementary to coupling topography in the aperture through the thickness of the member of the base element.

16. A system comprising:
a liquid-fillable dual lens element including:
a reservoir; and
a removable lens member configured to allow liquid to be added to and removed from the reservoir; and
a base element configured to hold the liquid-fillable dual lens element over a smartphone camera lens such that the liquid-fillable dual lens element can act as a filter allowing light to pass through an entire longitudinal length of the liquid-fillable dual lens element, and any liquid enclosed therein, to the camera lens.

17. The system of claim 16, wherein the removable lens member includes threads complementary to threads on a reservoir member defining the reservoir.

18. The system of claim 16, wherein the reservoir has a substantially circular cross section.

19. The system of claim 16, wherein the removable lens member includes one of two opposing lenses in the dual lens element.

20. The system of claim 16, wherein the base element comprises a spring-loaded clip configured to clip onto smartphones of various thicknesses.
